(19) United States
(12) Patent Application Publication
(10) Pub. No.: US 2021/0287088 A1
(43) Pub. Date: Sep. 16, 2021

(54) REINFORCEMENT LEARNING SYSTEM AND TRAINING METHOD

(71) Applicant: HTC Corporation, Taoyuan City (TW)

(72) Inventors: Yu-Shao PENG, Taoyuan City (TW); Kai-Fu TANG, Taoyuan City (TW); Edward CHANG, Taoyuan City (TW)

(21) Appl. No.: 17/198,259

(22) Filed: Mar. 11, 2021

Related U.S. Application Data
(60) Provisional application No. 62/987,883, filed on Mar. 11, 2020.

(51) Int. Cl. G06N 3/08; G06K 9/62; G06N 5/04

(52) U.S. Cl. CPC G06N 3/08; G06N 5/043; G06K 9/6262

(57) ABSTRACT

A training method suitable for a reinforcement learning system with a reward function to train a reinforcement learning model and including: defining at least one reward condition of the reward function; determining at least one reward value range corresponding to the at least one reward condition; searching for at least one reward value from the at least one reward value range by a hyperparameter tuning algorithm; and training the reinforcement learning model according to the at least one reward value.

### CROSS-REFERENCE TO RELATED APPLICATION

This application claims priority to U.S. Provisional Application Ser. No. 62/987,883, filed on Mar. 11, 2020, which is herein incorporated by reference.

### BACKGROUND

### Field of Invention

This disclosure relates to a reinforcement learning system and training method, and in particular to a reinforcement learning system and training method for training reinforcement learning model.

### Description of Related Art

For training the neural network model, the agent is provided with at least one reward value as the agent satisfies at least one reward condition (e.g. the agent executes appropriate action in response to the particular state). Different reward conditions usually correspond to different reward values. However, the slightly difference in a variety of combinations (or arrangements) of the reward values would cause the neural network models, which are trained according to each of the combinations of the reward values, to have different success rates. In practice, the reward values are usually intuitively set by the system designer, which may lead the neural network model trained accordingly to have poor success rate. Therefore, the system designer may have to spend much time to reset the reward values and train the neural network model again.

### SUMMARY

An aspect of present disclosure relates to a training method. The training method is suitable for a reinforcement learning system with a reward function to train a reinforcement learning model, and includes: defining at least one reward condition of the reward function; determining at least one reward value range corresponding to the at least one reward condition; searching for at least one reward value from the at least one reward value range by a hyperparameter tuning algorithm; and training the reinforcement learning model according to the at least one reward value.

Another aspect of present disclosure relates to a training method. The training method is suitable for a reinforcement learning system with a reward function to train a reinforcement learning model, wherein the reinforcement learning model is configured to select an action according to values of a plurality of input vectors, and the training method includes: encoding the input vectors into a plurality of embedding vectors; determining a plurality of reward value ranges corresponding to the embedding vectors; searching for a plurality of reward values from the reward value ranges by a hyperparameter tuning algorithm; and training the reinforcement learning model according to the reward values.

Another aspect of present disclosure relates to a reinforcement learning system with a reward function. The reinforcement learning system is suitable for training a reinforcement learning model, and includes a memory and a processor. The memory is configured to store at least one program code. The processor is configured to execute the at least one program code to perform operations including: defining at least one reward condition of the reward function; determining at least one reward value range corresponding to the at least one reward condition; searching for at least one reward value from the at least one reward value range by a hyperparameter tuning algorithm; and training the reinforcement learning model according to the at least one reward value.

Another aspect of present disclosure relates to a reinforcement learning system with a reward function. The reinforcement learning system is suitable for training a reinforcement learning model, wherein the reinforcement learning model is configured to select an action according to values of a plurality of input vectors, and the reinforcement learning system includes a memory and a processor. The memory is configured to store at least one program code. The processor is configured to execute the at least one program code to perform operations including: encoding the input vectors into a plurality of embedding vectors, by an encoder; determining a plurality of reward value ranges corresponding to the embedding vectors; searching for a plurality of reward values from the reward value ranges by a hyperparameter tuning algorithm; and training the reinforcement learning model according to the reward values.

In the above embodiments, the reward values corresponding to a variety of reward conditions can be automatically determined by the reinforcement learning system without manually determining the accurate numerical values by conducting experiment. Accordingly, the procedure or time for training the reinforcement learning model can be shortened. In summary, by determining the reward values corresponding to a variety of reward conditions, the reinforcement learning model trained by the reinforcement learning system can have a high chance of having the high success rate (or great performance) so as to select appropriate action.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of the reinforcement learning system in accordance with some embodiments of the present disclosure.

FIG. 2 is a flow diagram of the training method in accordance with some embodiments of the present disclosure.

FIG. 3 is a flow diagram of one of the operation of the training method of FIG. 2.

FIG. 4 is another flow diagram of one of the operation of the training method of FIG. 2.

FIG. 5 is a flow diagram of another one of the operation of the training method of FIG. 2.

FIG. 6 is a schematic diagram of another reinforcement learning system in accordance with other embodiments of the present disclosure.

FIG. 7 is a flow diagram of another training method in accordance with other embodiments of the present disclosure.

FIG. 8 is a schematic diagram of the transformation from the input vectors to the embedding vectors and to the output vectors in accordance with some embodiments of the present disclosure.

FIG. 9 is a flow diagram of one of the operation of the training method of FIG. 7.

FIG. 10 is another flow diagram of one of the operation of the training method of FIG. 7.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

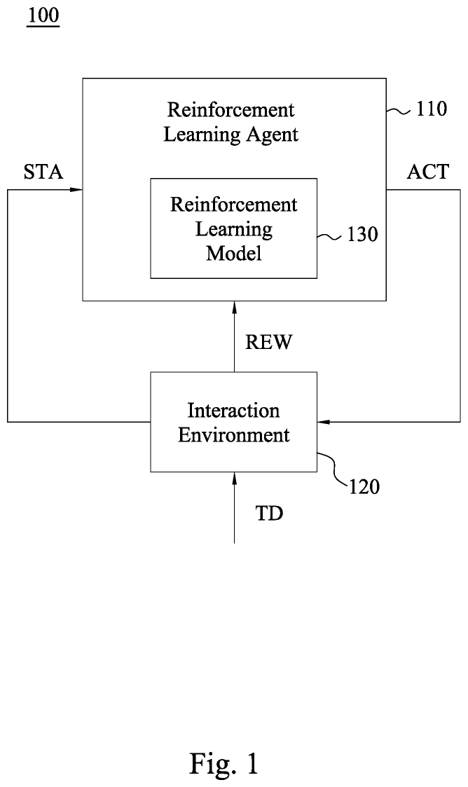

Referring to FIG. 1, FIG. 1 depicts a reinforcement learning system 100 in accordance with some embodiments of the present disclosure. The reinforcement learning system 100 has a reward function, includes a reinforcement learning agent 110 and an interaction environment 120 and is implemented as one or more program codes that may be stored by a memory (not shown) and be executed by a processor (not shown). The reinforcement learning agent 110 and the interaction environment 120 interact with each other. In such arrangement, the reinforcement learning system 100 is able to train a reinforcement learning model 130.

In some embodiments, the processor is implemented by one or more central processing unit (CPU), application-specific integrated circuit (ASIC), microprocessor, system on a Chip (SoC), graphics processing unit (GPU) or other suitable processing units. The memory is implemented by a non-transitory computer readable storage medium (e.g. random access memory (RAM), read only memory (ROM), hard disk drive (HDD), solid-state drive (SSD)).

As shown in FIG. 1, the interaction environment 120 is configured to receive training data TD and provides a current state STA from a plurality of states characterizing the interaction environment 120 according to the training data TD. In some embodiments, the interaction environment 120 can provide the current state STA without the training data TD. The reinforcement learning agent 110 is configured to execute an action ACT in response to the current state STA. In particular, the reinforcement learning model 130 is utilized by the reinforcement learning agent 110 to select the action ACT from a plurality of candidate actions. In some embodiments, a plurality of reward conditions are defined according to different combinations of the states and the candidate actions. After the action ACT is executed by the reinforcement learning agent 110, the interaction environment 120 evaluates if the action ACT executed in response to the current state STA leads to one of the reward conditions. Accordingly, the interaction environment 120 provides the reinforcement learning agent 110 with a reward value REW that is corresponding to the one of the reward conditions.

The action ACT executed by the reinforcement learning agent 110 causes the interaction environment 120 to move from the current state STA to a new state. Again, the reinforcement learning agent 110 executes another action in response to the new state to obtain another reward value. In some embodiments, the reinforcement learning agent 110 trains the reinforcement learning model 130 (e.g. adjusting a set of parameters of the reinforcement learning model 130) to maximize the total of the reward values that are collected from the interaction environment 120.

In general, the reward values that are corresponding to the reward conditions would be determined before the reinforcement learning model 130 is trained. In a first example of playing Go game, two reward conditions and two corresponding reward values are provided. A first reward condition is that the agent (not shown) wins the Go game, and a first reward value is correspondingly set as “+1”. A second reward condition is that the agent loses the Go game, and a second reward value is correspondingly set as “−1”. The neural network model (not shown) is trained by the agent according to the first and the second reward values, so as to obtain a first success rate. In a second example of playing Go game, the first reward value is set as “+2”, the second reward value is set as “−2”, and a second success rate is obtained. For obtaining the success rate (e.g. the first success rate, the second success rate), the neural network model that has been trained by the agent is utilized to play a number of Go games. In some embodiments, the success rate is calculated by dividing the winning number of playing Go games by the total number of playing Go games.

Since the reward values of the first example and the reward values of the second example is slightly different only, people skilled in the art normally think that the first success rate would equal the second success rate. Accordingly, people skilled in the art barely choose between the reward values of the first example and the reward values of the second example for training the neural network model. However, the slightly difference between the reward values of the first example and the second example would lead to different success rates according to the result of actual experiment. Therefore, providing appropriate reward values is critical for training the neural network model.

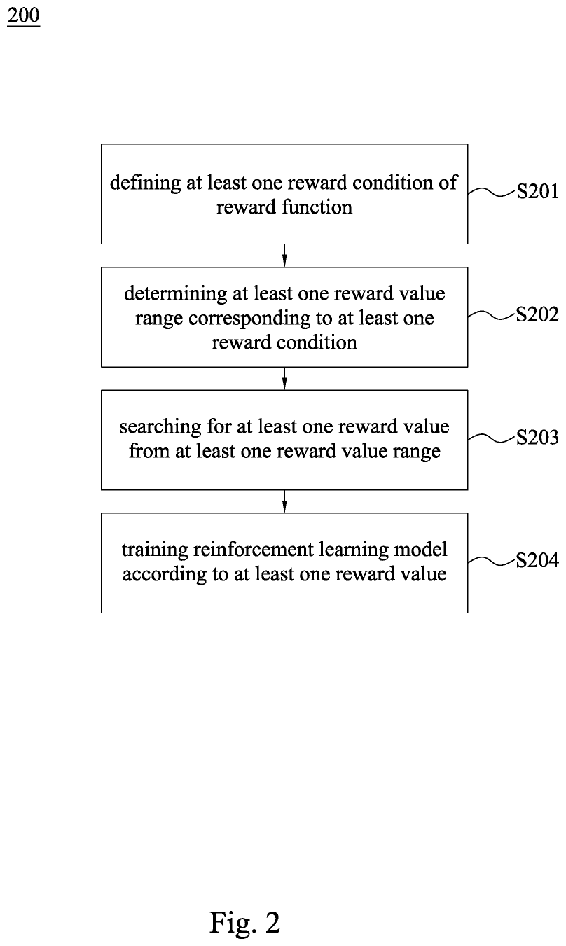

Referring to FIG. 2, a training method 200 in accordance with some embodiments of the present disclosure is provided. The training method 200 can be performed by the reinforcement learning system 100 of FIG. 1, so as to provide appropriate reward values for training the reinforcement learning model 130. However, the present disclosure should not be limited thereto. As shown in FIG. 2, the training method 200 includes operations S201-S204.

In the operation S201, the reinforcement learning system 100 defines at least one reward condition of the reward function. In some embodiments, the reward condition is defined by receiving a reference table (not shown) predefined by the user.

In the operation S202, the reinforcement learning system 100 determines at least one reward value range corresponding to the at least one reward condition. In some embodiments, the reward value range is determined according to one or more rules (not shown) that are provided by the user and stored in the memory. Specifically, each reward value range includes a plurality of selected reward values. In some embodiments, each of the selected reward value may be an integer or a float.

In an example of controlling the robotic arm to fill the cup with water, four reward conditions A-D are defined, and four reward value ranges REW[A]-REW[D], which are corresponding to the reward conditions A-D, are determined. Specifically, the reward condition A is that the robotic arm holds nothing and moves towards the cup, and the reward value range REW[A] ranges from “+1” to “+5”. The reward condition B is that the robotic arm grabs the kettle filled with water, and the reward value range REW[B] ranges from “+1” to “+4”. The reward condition C is that the robotic arm grabs the kettle filled with water and fills the cup with the water, and the reward value range REW[C] ranges from “+1” to “+9”. The reward condition D is that the robotic arm grabs the kettle filled with water and dumps the water to the outside of the cup, and the reward value range REW[D] ranges from “−5” to “−1”.

In the operation S203, the reinforcement learning system 100 searches for at least one reward value from the selected reward values of the at least one reward value range. Specifically, the at least one reward value is searched by a hyperparameter tuning algorithm.

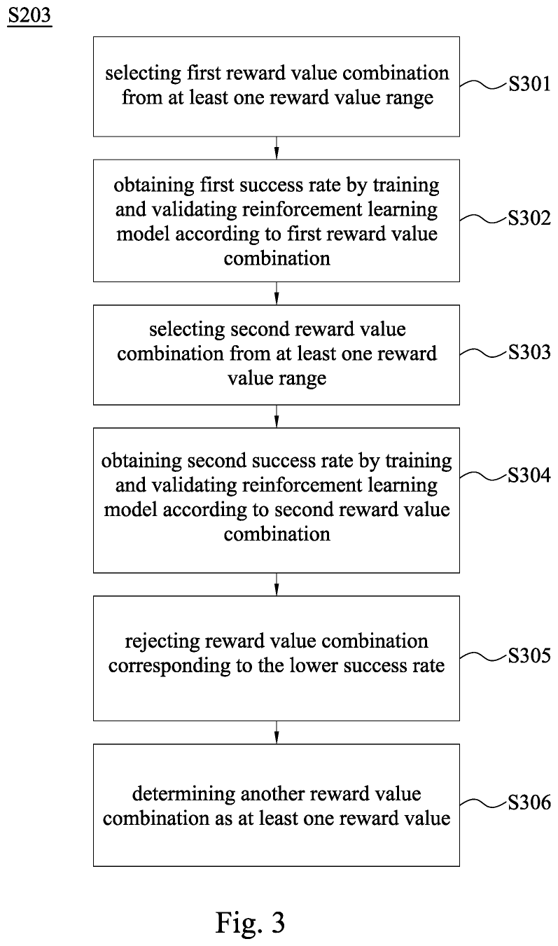

Referring to FIG. 3, in some embodiments, the operation S203 includes sub-operations S301-S306. In the sub-operation S301, the reinforcement learning system 100 selects a first reward value combination from the at least one reward value range (e.g. selecting “+1” from the reward value range REW[A], selecting “+1” from the reward value range REW[B], selecting “+1” from the reward value range REW[C] and selecting “−1” from the reward value range REW[D]). In the sub-operation S302, the reinforcement learning system 100 obtains a first success rate (e.g. 65%) by training and validating the reinforcement learning model 130 according to the first reward value combination. In the sub-operation S303, the reinforcement learning system 100 selects a second reward value combination from the at least one reward value range (e.g. selecting “+2” from the reward value range REW[A], selecting “+2” from the reward value range REW[B], selecting “+2” from the reward value range REW[C] and selecting “−2” from the reward value range REW[D]). In the sub-operation S304, the reinforcement learning system 100 obtains a second success rate (e.g. 72%) by training and validating the reinforcement learning model 130 according to the second reward value combination. In the sub-operation S305, the reinforcement learning system 100 rejects one reward value combination corresponding to the lower success rate (e.g. rejecting the above-described first reward value combination). In the sub-operation S306, the reinforcement learning system 100 determines another reward value combination (e.g. the above-described second reward value combination) as the at least one reward value.

In some embodiments, the sub-operations S301-S305 are repeatedly executed until the reward value combination corresponding to the highest success rate is remained only. Accordingly, the sub-operation S306 is executed to determine the last non-rejected reward value combination as the at least one reward value.

In other embodiments, after the sub-operation S304 is executed, the reinforcement learning system 100 compares the first success rate and the second success rate, so as to determine the reward value combination (e.g. the above-described second reward value combination) corresponding to the higher success rate as the at least one reward value.

In some embodiments, the sub-operations S301 and S303 are combined. Accordingly, the reinforcement learning system 100 selects at least two reward value combinations from the at least one reward value range. For example, the first reward value combination includes “+1”, “+1”, “+1” and “−1”, which are respectively selected from the reward value ranges REW[A]-REW[D]. The second reward value combination includes “+3”, “+2”, “+5” and “−3”, which are respectively selected from the reward value ranges REW[A]-REW[D]. The third reward value combination includes “+5”, “+4”, “+9” and “−5”, which are respectively selected from the reward value ranges REW[A]-REW[D].

The sub-operations S302 and S304 can also be combined, and the combined sub-operations S302 and S304 are executed after the execution of the combined sub-operations S301 and S303. Accordingly, the reinforcement learning system 100 trains the reinforcement learning model 130 according to the at least two reward value combinations and obtains at least two success rates by validating the reinforcement learning model 130. For example, the first success rate (e.g. 65%) is obtained according to the first reward value combination (including “+1”, “+1”, “+1” and “−1”). The second success rate (e.g. 75%) is obtained according to the second reward value combination (including “+3”, “+2”, “+5” and “−3”). The third success rate (e.g. 69%) is obtained according to the third reward value combination (including “+5”, “+4”, “+9” and “−5”).

After the execution of the combined sub-operations S302 and S304, another sub-operation is executed so that the reinforcement learning system 100 rejects at least one reward value combination corresponding to the lower success rate. In some embodiments, the first reward value combination corresponding to the first success rate (e.g. 65%) is rejected only. The second reward value combination and the third reward value combination are then used by the reinforcement learning system 100 to further train the reinforcement learning model 130, which has been trained and validated in the combined sub-operations S302 and S304. After training the reinforcement learning model 130 according to the second reward value combination and the third reward value combination, the reinforcement learning system 100 further validates the reinforcement learning model 130. In such way, a new second success rate and a new third success rate are obtained. The reinforcement learning system 100 rejects one reward value combination (the second reward value combination or the third reward value combination) corresponding to the lower success rate (the new second success rate or the new third success rate). Accordingly, the reinforcement learning system 100 determines the other one of the second reward value combination and the third reward value combination as the at least one reward value.

In the above-described embodiments, the reinforcement learning system 100 only rejects the first reward value combination corresponding to the first success rate (e.g. 65%) in first. Then, another reward value combination (the second reward value combination or the third reward value combination) is rejected. However, the present disclosure is not limited herein. In other embodiments, the reinforcement learning system 100 directly rejects the first reward value combination corresponding to the first success rate (e.g. 65%) and the third reward value combination corresponding to the third success rate (e.g. 69%). Accordingly, the reinforcement learning system 100 determines the second reward value combination corresponding to the highest success rate (e.g. 75%) as the at least one reward value.

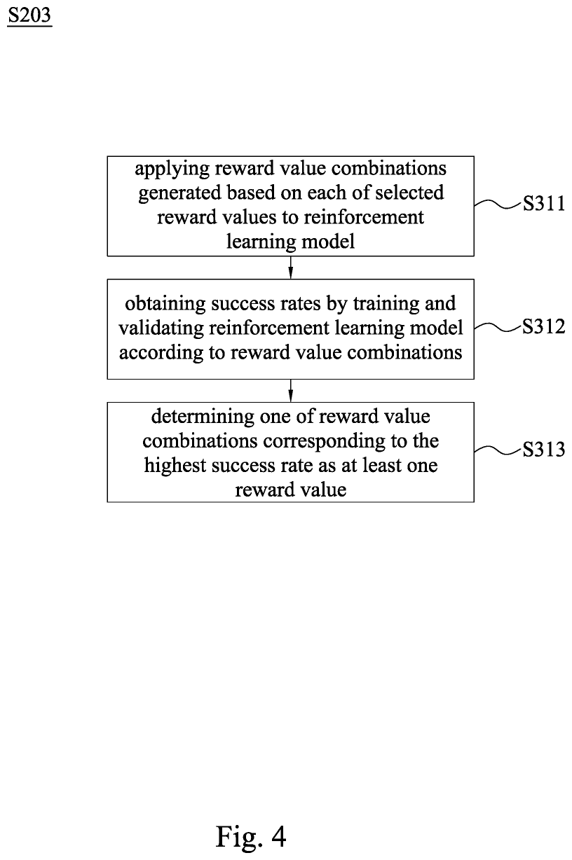

Referring to FIG. 4, in other embodiments, the operation S203 includes sub-operations S311-S313. In the sub-operation S311, the reinforcement learning system 100 applies a plurality of reward value combinations generated based on each of the selected reward values (for example, the reinforcement learning system 100 defines two reward conditions corresponding to the reward value ranges REW[A] and REW[B]. The reward value ranges REW[A] might be (“+1”, “+2”, “+3”). The reward value ranges REW[B] might be (“−2”, “−1”, “0”). Accordingly, the reward value combinations generated based on each of the selected reward values include 9 combinations such as (“+1”, “−1”), (“+1”, “0”), (“+1”, “−2”), (“+2”, “−1”), (“+2”, “−2”), (“+2”, “0”), (“+3”, “−2”), (“+3”, “−1”) and (“+3”, “0”).) to the reinforcement learning model 130. In the sub-operation S312, the reinforcement learning system 100 obtains a plurality of success rates by training and validating the reinforcement learning model 130 according to the reward value combinations. In the sub-operation S313, the reinforcement learning system 100 determines one reward value combination corresponding to the highest success rate as the at least one reward value.

In other embodiments, the reward value range may include infinite number of numerical values. Accordingly, a predetermined number of the selected reward values can be sampled from the infinite number of numerical values and the reinforcement learning system 100 can apply a plurality of reward value combinations generated based on the predetermined number of the selected reward values to the reinforcement learning model 130.

In the above-described embodiments, since there would be multiple reward conditions, each reward value combination might include multiple selected reward values from different reward value ranges (e.g. reward value ranges REW[A]-REW[D]). However, the present disclosure is not limited herein. In other practical examples, one reward condition and one corresponding reward value range are only defined. Accordingly, each reward value combination might only include one selected reward value.

After the reward value is determined in the operation S203, the operation S204 is executed. In the operation S204, the reinforcement learning system 100 trains the reinforcement learning model 130 according to the reward value.

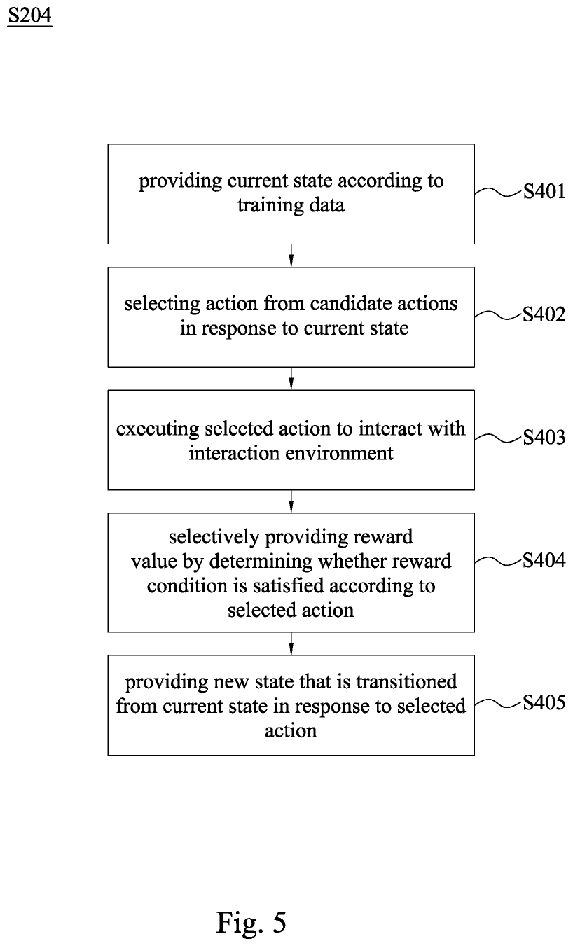

Referring to FIG. 5, in some embodiments, the operation S204 includes sub-operations S401-S405. As shown in FIG. 1, in the sub-operation S401, the interaction environment 120 provides the current state STA according to the training data TD. In other embodiments, the interaction environment 120 can provide the current state STA without the training data TD. In the sub-operation S402, the reinforcement learning agent 110 utilizes the reinforcement learning model 130 to select the action ACT from the candidate actions in response to the current state STA. In the sub-operation S403, the reinforcement learning agent 110 executes the action ACT to interact with the interaction environment 120. In the sub-operation S404, the interaction environment 120 selectively provides the reward value by determining whether the reward condition is satisfied according to the action ACT executed in response to the current state STA. In the sub-operation S405, the interaction environment 120 provides a new state that is transitioned from the current state STA in response to the action ACT. The training of the reinforcement learning model 130 includes a plurality of training phases. The sub-operations S401-S405 are repeatedly executed in each of the training phases. The training of the reinforcement learning model 130 would be finished as the training phases are all completed. For example, each of the training phases might correspond to one Go game, so that the reinforcement learning agent 110 might play multiple Go games during the training of the reinforcement learning model 130.

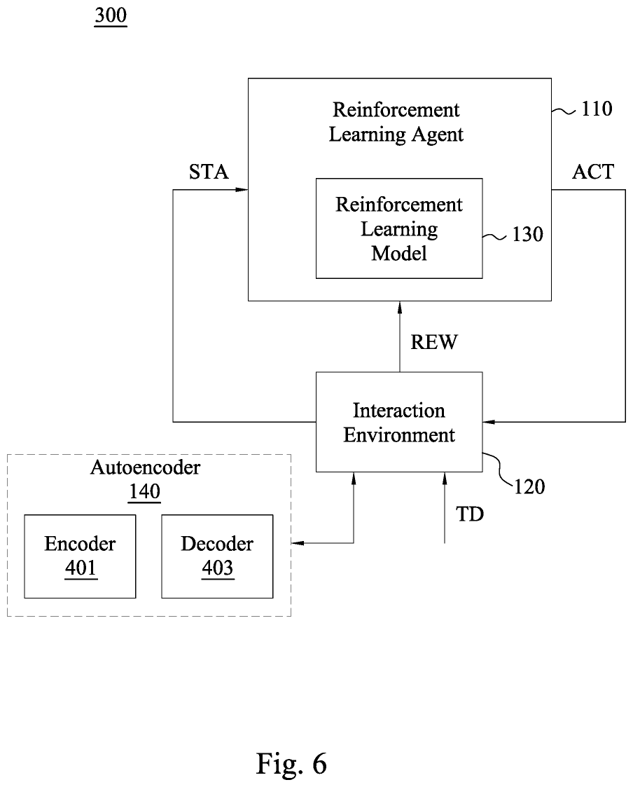

Referring to FIG. 6, FIG. 6 depicts another reinforcement learning system 300 in accordance with other embodiments of the present disclosure. Comparing to the reinforcement learning system 100 of FIG. 1, the reinforcement learning system 300 further includes an autoencoder 140. The autoencoder 140 is coupled to the interaction environment 120 and includes an encoder 401 and a decoder 403.

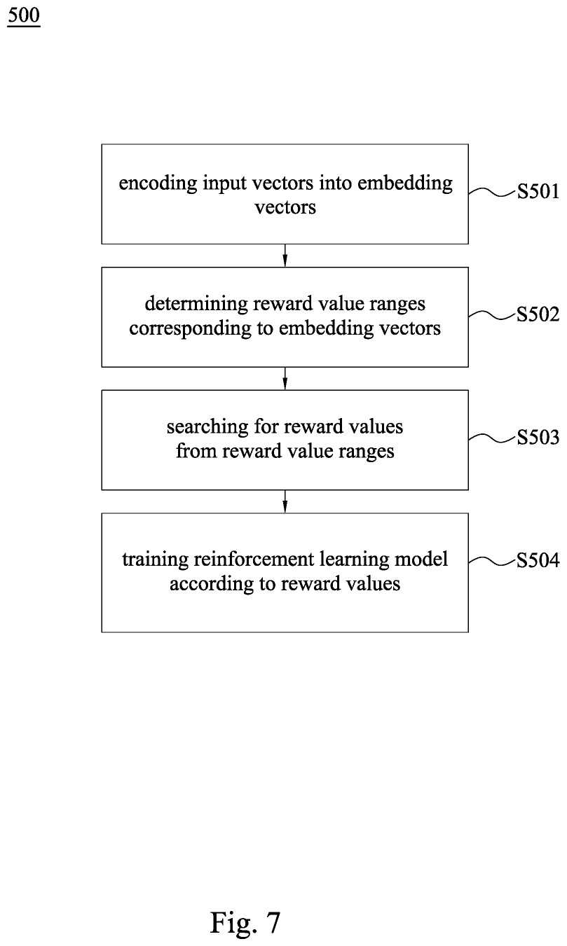

Referring to FIG. 7, another training method 500 in accordance with other embodiments of the present disclosure is provided. The training method 500 can be performed by the reinforcement learning system 300 of FIG. 6, so as to provide appropriate reward values for training the reinforcement learning model 130. In some embodiments, the reinforcement learning model 130 is configured to select one of the candidate actions (e.g. the action ACT as shown in FIG. 6) according to values of a plurality of input vectors. As shown in FIG. 7, the training method 500 includes operations S501-S504.

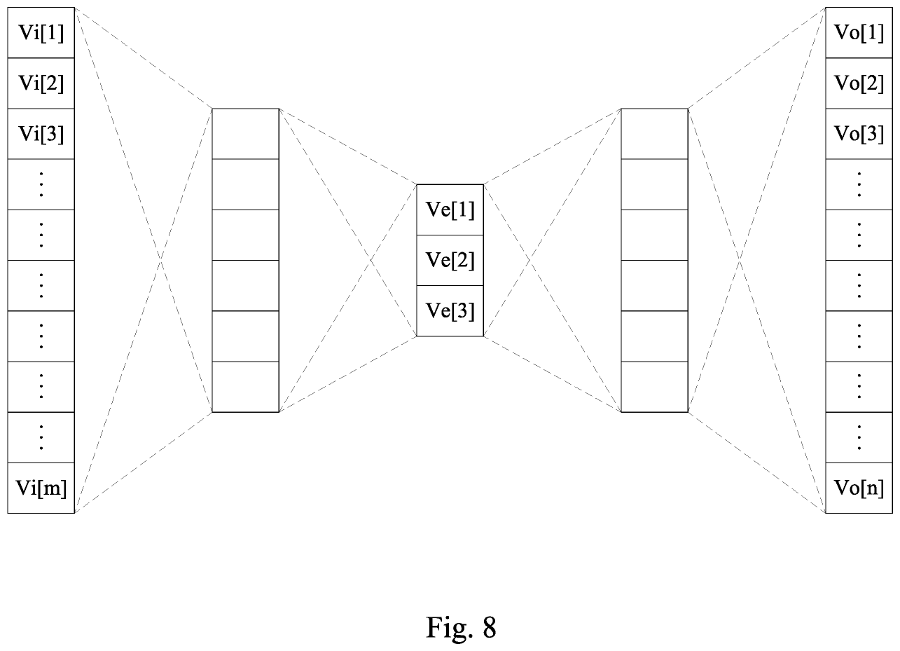

In the operation S501, the reinforcement learning system 300 encodes the input vectors into a plurality of embedding vectors. Referring to FIG. 8, in some embodiments, the input vectors Vi[1]-Vi[m] are encoded into the embedding vectors Ve[1]-Ve[3] by the encoder 401, where m is the positive integer. Each of the input vectors Vi[1]-Vi[m] includes values corresponding to a combination of the selected actions and the current state. In some practical examples, the current state can be the position of the robotic arm, the angle of the robotic arm or the rotational state of the robotic arm, and the selected actions include horizontally moving towards right, horizontally moving towards left and rotating the wrist of the robotic arm. The embedding vectors Ve[1]-Ve[3] carry information equivalent to the input vectors Vi[1]-Vi[m] in different vector dimension, and can be recognized by the interaction environment 120 of the reinforcement learning system 300. Accordingly, the embedding vectors Ve[1]-Ve[3] can be decoded and resume to be the input vectors Vi[1]-Vi[m] again.

In other embodiments, definitions and meanings of the embedding vectors Ve[1]-Ve[3] are not recognizable to a person. The reinforcement learning system 300 can verify the embedding vectors Ve[1]-Ve[3]. As shown in FIG. 8, the embedding vectors Ve[1]-Ve[3] are decoded into a plurality of output vectors Vo[1]-Vo[n], where n is the positive integer and is equal to m. The output vectors Vo[1]-Vo[n] are then compared with the input vectors Vi[1]-Vi[m] to verify the embedding vectors Ve[1]-Ve[3]. In some embodiments, the embedding vectors Ve[1]-Ve[3] are verified as values of the output vectors Vo[1]-Vo[n] equal the values of the input vectors Vi[1]-Vi[m]. It is worth noting that the values of the output vectors Vo[1]-Vo[n] can be nearly equal to the values of the input vectors Vi[1]-Vi[m]. In other words, few values of the output vectors Vo[1]-Vo[n] might be different to the few corresponding values of the input vectors Vi[1]-Vi[m]. In other embodiments, the verification of the embedding vectors Ve[1]-Ve[3] fails as the values of the output vectors Vo[1]-Vo[n] are completely different to the values of the input vectors Vi[1]-Vi[m], so that the encoder 401 is going to encode the input vectors Vi[1]-Vi[m] again.

In some embodiments, the dimension of the input vectors Vi[1]-Vi[m] and the dimension of the output vectors Vo[1]-Vo[n] are greater than the dimension of the embedding vectors Ve[1]-Ve[3] (for example, both m and n are greater than 3).

After the embedding vectors are verified, the reinforcement learning system 300 executes the operation S502. In the operation S502, the reinforcement learning system 300 determines a plurality of reward value ranges corresponding to the embedding vectors, and each of the reward value ranges includes a plurality of selected reward values. In some embodiments, each of the selected reward value may be an integer or a float. In the example of the embedding vectors Ve[1]-Ve[3], the reward value range corresponding to the embedding vector Ve[1] ranges from “+1” to “+10”, the reward value range corresponding to the embedding vector Ve[2] ranges from “−1” to “−10”, and the reward value range corresponding to the embedding vector Ve[3] ranges from “+7” to “+14”.

In the operation S503, the reinforcement learning system 300 searches for a plurality of reward values from the reward value ranges. Specifically, the reward values are searched from the reward value ranges by a hyperparameter tuning algorithm.

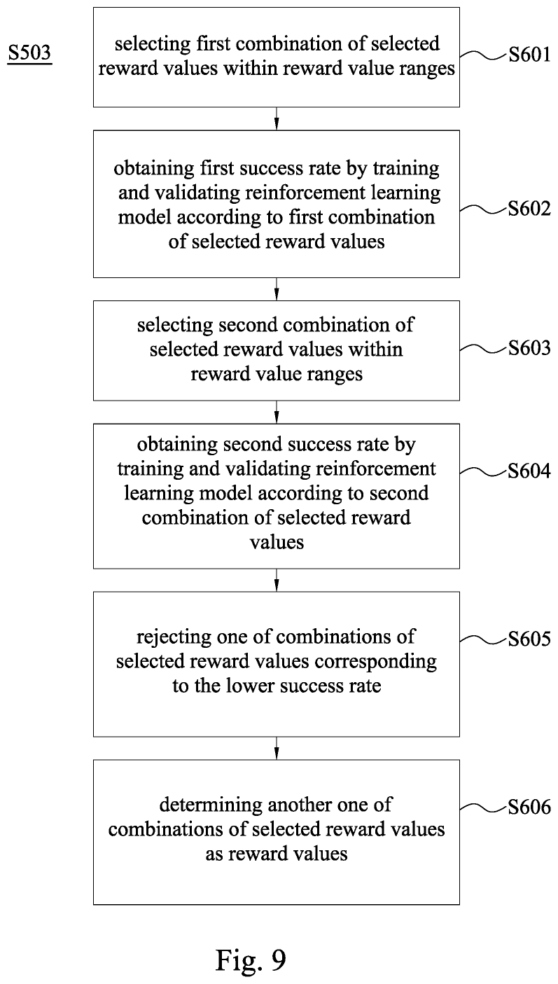

Referring to FIG. 9, in some embodiments, the operation S503 includes sub-operations S601-S606. In the sub-operation S601, the reinforcement learning system 300 selects a first combination of the selected reward values within the reward value ranges. In the example of the embedding vectors Ve[1]-Ve[3], the first combination of the selected reward values are composed of “+1”, “−1” and “+7”. In the sub-operation S602, the reinforcement learning system 300 obtains a first success rate (e.g. 54%) by training and validating the reinforcement learning model 130 according to the first combination of the selected reward values.

In the sub-operation S603, the reinforcement learning system 300 selects a second combination of the selected reward values within the reward value ranges. In the example of the embedding vectors Ve[1]-Ve[3], the second combination of the selected reward values are composed of “+2”, “−2” and “+8”. In the sub-operation S604, the reinforcement learning system 300 obtains a second success rate (e.g. 58%) by training and validating the reinforcement learning model 130 according to the second combination of the selected reward values.

In the sub-operation S605, the reinforcement learning system 300 rejects one of the combinations of the selected reward values corresponding to the lower success rate. In the sub-operation S606, the reinforcement learning system 300 determines another one of the combinations of the selected reward values as the reward values. In the example of the embedding vectors Ve[1]-Ve[3], the reinforcement learning system 300 rejects the first combination of the selected reward values and determines the second combination of the selected reward values as the reward values.

In other embodiments, after the sub-operation S604 is executed, the reinforcement learning system 300 compares the first success rate and the second success rate, so as to determine one of the combinations of the selected reward values corresponding to the higher success rate as the reward values.

In other embodiments, the operations S601-S605 are repeatedly executed until the combination of the selected reward value corresponding to the highest success rate is remained only. Accordingly, the operation S606 is executed to determine the last one of the non-rejected combinations of the selected reward values as the reward values.

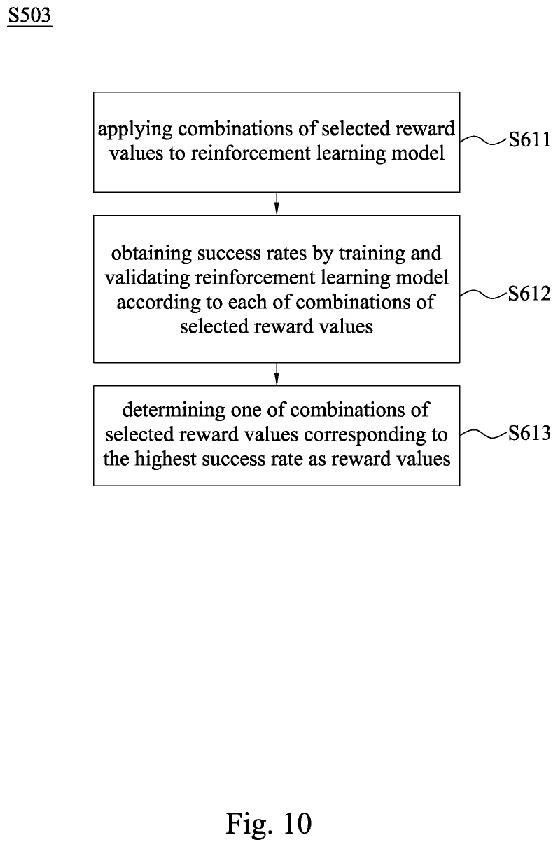

Referring to FIG. 10, in other embodiments, the operation S503 includes sub-operations S611-S613. In the sub-operation S611, the reinforcement learning system 300 applies a plurality of combinations (e.g. the first combination including “+1”, “−1” and “+7”, the second combination including “+3”, “−3” and “+9”, the third combination including “+5”, “−5” and “+11”) of the selected reward values to the reinforcement learning model 130. In the sub-operation S612, the reinforcement learning system 300 obtains a plurality of success rates (for example, the success rates of the first, the second and the third combinations are respectively “54%”, “60%” and “49%”) by training and validating the reinforcement learning model 130 according to each of the combinations of the selected reward values. In the sub-operation S613, the reinforcement learning system 300 determines one of the combinations (e.g. the second combination) of the selected reward values corresponding to the highest success rate (e.g. the second success rate) as the reward values.

As set forth above, since the definitions and the meanings of the embedding vectors are not recognizable to the person, there would not be one or more reasonable rules to help in determining the reward values corresponding to the embedding vectors. Accordingly, the reinforcement learning system 300 of the present disclosure determines the reward values by the hyperparameter tuning algorithm.

After the reward values are determined, the operation S504 is executed. In the operation S504, the reinforcement learning system 300 trains the reinforcement learning model 130 according to the reward values. The operation S504 is similar to the operation S204, and therefore the description thereof is omitted herein.

In the above embodiments, the reward values corresponding to a variety of reward conditions can be automatically determined by the reinforcement learning system 100/300 without manually determining the accurate numerical values by conducting experiment. Accordingly, the procedure or time for training the reinforcement learning model 130 can be shortened. In summary, by automatically determining the reward values corresponding to a variety of reward conditions, the reinforcement learning model 130 trained by the reinforcement learning system 100/300 can have a high chance of having the high success rate (or great performance) so as to select appropriate action.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A training method, suitable for a reinforcement learning system with a reward function to train a reinforcement learning model, and comprising:
defining at least one reward condition of the reward function;
determining at least one reward value range corresponding to the at least one reward condition;
searching for at least one reward value from the at least one reward value range by a hyperparameter tuning algorithm; and
training the reinforcement learning model according to the at least one reward value.

2. The training method of claim 1, wherein the at least one reward value range comprises a plurality of selected reward values, and the operation of searching for the at least one reward value from the at least one reward value range comprises:
selecting a first reward value combination from the at least one reward value range, wherein the first reward value combination comprises at least one selected reward value;
obtaining a first success rate by training and validating the reinforcement learning model according to the first reward value combination;
selecting a second reward value combination from the at least one reward value range, wherein the second reward value combination comprises at least one selected reward value;
obtaining a second success rate by training and validating the reinforcement learning model according to the second reward value combination; and
comparing the first success rate and the second success rate to determine the at least one reward value.

3. The training method of claim 2, wherein the operation of determining the at least one reward value comprises:
determining one of the first reward value combination and the second reward value combination corresponding to the higher success rate as the at least one reward value.

4. The training method of claim 1, wherein the at least one reward value range comprises a plurality of selected reward values, and the operation of searching for the at least one reward value from the at least one reward value range comprises:
applying a plurality of reward value combinations generated based on each of the selected reward values to the reinforcement learning model, wherein each of the reward value combinations comprises at least one selected reward value;
obtaining a plurality of success rates by training and validating the reinforcement learning model according to the reward value combinations; and
determining one of the reward value combinations corresponding to the highest success rate as the at least one reward value.

5. The training method of claim 1, wherein the operation of training the reinforcement learning model according to the at least one reward value comprises:
providing a current state, by an interaction environment, according to training data;
selecting an action from a plurality of candidate actions, by the reinforcement learning model, in response to the current state;
executing the selected action, by a reinforcement learning agent, to interact with the interaction environment;
selectively providing the at least one reward value, by the interaction environment, by determining whether the at least one reward condition is satisfied according to the selected action executed in response to the current state; and
providing a new state that is transitioned from the current state, by the interaction environment, in response to the selected action.

6. A training method, suitable for a reinforcement learning system with a reward function to train a reinforcement learning model, wherein the reinforcement learning model is configured to select an action according to values of a plurality of input vectors, and the training method comprises:
encoding the input vectors into a plurality of embedding vectors;
determining a plurality of reward value ranges corresponding to the embedding vectors;
searching for a plurality of reward values from the reward value ranges by a hyperparameter tuning algorithm; and
training the reinforcement learning model according to the reward values.

7. The training method of claim 6, wherein each of the reward value ranges comprises a plurality of selected reward values, and the operation of searching for the reward values from the reward value ranges comprises:
selecting a first combination of the selected reward values within the reward value ranges;
obtaining a first success rate by training and validating the reinforcement learning model according to the first combination of the selected reward values;
selecting a second combination of the selected reward values within the reward value ranges;
obtaining a second success rate by training and validating the reinforcement learning model according to the second combination of the selected reward values; and
comparing the first success rate and the second success rate to determine the reward values.

8. The training method of claim 7, wherein the operation of determining the reward values comprises:
determining one of the combinations of the selected reward values corresponding to the higher success rate as the reward values.

9. The training method of claim 6, wherein each of the reward value ranges comprises a plurality of selected reward values, and the operation of searching for the reward values from the reward value ranges comprises:
applying a plurality of combinations of the selected reward values to the reinforcement learning model;
obtaining a plurality of success rates by training and validating the reinforcement learning model according to each of the combinations of the selected reward values; and
determining one of the combinations of the selected reward values corresponding to the highest success rate as the reward values.

10. The training method of claim 6, wherein the dimension of the input vectors is greater than the dimension of the embedding vectors.

11. A reinforcement learning system, with a reward function and suitable for training a reinforcement learning model, and comprising:
a memory configured to store at least one program code; and
a processor configured to execute the at least one program code to perform operations comprising:
defining at least one reward condition of the reward function;
determining at least one reward value range corresponding to the at least one reward condition;
searching for at least one reward value from the at least one reward value range by a hyperparameter tuning algorithm; and
training the reinforcement learning model according to the at least one reward value.

12. The reinforcement learning system of claim 11, wherein the at least one reward value range comprises a plurality of selected reward values, and the operation of searching for the at least one reward value from the at least one reward value range comprises:
selecting a first reward value combination from the at least one reward value range, wherein the first reward value combination comprises at least one selected reward value;
obtaining a first success rate by training and validating the reinforcement learning model according to the first reward value combination;
selecting a second reward value combination from the at least one reward value range, wherein the second reward value combination comprises at least one selected reward value;
obtaining a second success rate by training and validating the reinforcement learning model according to the second reward value combination; and
comparing the first success rate and the second success rate to determine the at least one reward value.

13. The reinforcement learning system of claim 12, wherein the operation of determining the at least one reward value comprises:
determining one of the first reward value combination and the second reward value combination corresponding to the higher success rate as the at least one reward value.

14. The reinforcement learning system of claim 11, wherein the at least one reward value range comprises a plurality of selected reward values, and the operation of searching for the at least one reward value from the at least one reward value range comprises:
applying a plurality of reward value combinations generated based on each of the selected reward values to the reinforcement learning model, wherein each of the reward value combinations comprises at least one selected reward value;
obtaining a plurality of success rates by training and validating the reinforcement learning model according to the reward value combinations; and
determining one of the reward value combinations corresponding to the highest success rate as the at least one reward value.

15. The reinforcement learning system of claim 11, wherein the operation of training the reinforcement learning model according to the at least one reward value comprises:
providing a current state, by an interaction environment, according to training data;
selecting an action from a plurality of candidate actions, by the reinforcement learning model, in response to the current state;
executing the selected action, by a reinforcement learning agent, to interact with the interaction environment;
selectively providing the at least one reward value, by the interaction environment, based on whether the at least one reward condition is satisfied according to the selected action executed in response to the current state; and
providing a new state that is transitioned from the current state, by the interaction environment, in response to the selected action.

16. A reinforcement learning system, with a reward function and suitable for training a reinforcement learning model, wherein the reinforcement learning model is configured to select an action according to values of a plurality of input vectors, and the reinforcement learning system comprises:
a memory configured to store at least one program code; and
a processor configured to execute the at least one program code to perform operations comprising:
encoding the input vectors into a plurality of embedding vectors, by an encoder;
determining a plurality of reward value ranges corresponding to the embedding vectors;
searching for a plurality of reward values from the reward value ranges by a hyperparameter tuning algorithm; and
training the reinforcement learning model according to the reward values.

17. The reinforcement learning system of claim 16, wherein each of the reward value ranges comprises a plurality of selected reward values, and the operation of searching for the reward values from the reward value ranges comprises:
selecting a first combination of the selected reward values within the reward value ranges;
obtaining a first success rate by training and validating the reinforcement learning model according to the first combination of the selected reward values;
selecting a second combination of the selected reward values within the reward value ranges;
obtaining a second success rate by training and validating the reinforcement learning model according to the second combination of the selected reward values; and
comparing the first success rate and the second success rate to determine the reward values.

18. The reinforcement learning system of claim 17, wherein the operation of determining the reward values comprises:
determining one of the combinations of the selected reward values corresponding to the higher success rate as the reward values.

19. The reinforcement learning system of claim 16, wherein each of the reward value ranges comprises a plurality of selected reward values, and the operation of searching for the reward values from the reward value ranges comprises:
applying a plurality of combinations of the selected reward values to the reinforcement learning model;
obtaining a plurality of success rates by training and validating the reinforcement learning model according to each of the combinations of the selected reward values; and
determining one of the combinations of the selected reward values corresponding to the highest success rate as the reward values.

20. The reinforcement learning system of claim 16, wherein the dimension of the input vectors is greater than the dimension of the embedding vectors.
